(19) United States
(12) Patent Application Publication
(10) Pub. No.: US 2010/0237711 A1
(43) Pub. Date: Sep. 23, 2010

(54) Occupancy Sensing With Device Clock

(75) Inventor: Kevin Parsons, Wilsonville, OR (US)

Correspondence Address: Marger Johnson & McCollom PC - Leviton, 210 SW Morrison, Suite 400, Portland, OR, 97204, US

(73) Assignee: LEVITON MANUFACTURING CO., INC., Little Neck, NY (US)

(21) Appl. No.: 12/406,806

(22) Filed: Mar. 18, 2009

(51) Int. Cl. H01H 35/00

(52) U.S. Cl. 307/116

(57) ABSTRACT

An occupancy sensing system includes a device clock included in an assembly with a device such as a switching device or an occupancy sensor. The device clock enables time tracking functionality to be combined with occupancy sensing to control lighting and other loads. A display and/or interface may be included to enable a user to a set the time-of-day, day-of-week and program and configure the device clock.

### BACKGROUND

Occupancy sensing technologies are used to monitor the presence of human occupants in indoor and outdoor spaces. Occupancy sensing systems conserve energy by automatically turning off lighting and other electrical loads when the space is unoccupied. They may also perform a convenience function by automatically turning on lighting and other loads when an occupant enters a space. Occupancy sensing systems generally include two major components: an occupancy sensor and a switching device.

The occupancy sensor includes one or more detectors based any of numerous different sensing technologies such as passive infrared (PIR) sensing, ultrasonic (U/S) sensing, audio sensing, video sensing, etc. The occupancy sensor typically includes logic to process signals from the detector and provide an on/off signal that indicates whether the space is occupied or unoccupied. The logic may include features such as a built-in-time delay to prevent a false turn-off of the load while the space is still occupied.

The switching device controls the flow of power to lighting and other electrical loads for the space in response to the on/off signal from the occupancy sensor. Examples of switching devices used with occupancy sensing systems include air-gap relays, thyristors such as silicon controlled rectifiers (SCRs) and triacs, etc. The switching device may be located in the same enclosure as the occupancy sensor, for example, in a wall switch occupancy sensor. The switching device may alternatively be located in a separate enclosure remote from the occupancy sensor; for example, in a power pack attached to a light fixture or a junction box.

### BRIEF DESCRIPTION OF THE DRAWINGS

FIG. 1 illustrates an embodiment of an occupancy sensing system having a switching device with a clock according to some of the inventive principles of this patent disclosure.

FIG. 2 illustrates another embodiment of an occupancy sensing system having a switching device with a clock according to some of the inventive principles of this patent disclosure.

FIG. 3 illustrates an embodiment of an occupancy sensing system having an occupancy sensor with a clock according to some of the inventive principles of this patent disclosure.

FIG. 4 illustrates another embodiment of an occupancy sensing system having an occupancy sensor with a clock according to some of the inventive principles of this patent disclosure.

FIG. 5 illustrates an embodiment of an occupancy sensor having a switching device and clock according to some of the inventive principles of this patent disclosure.

FIG. 6 illustrates an embodiment of a clock unit according to some of the inventive principles of this patent disclosure.

FIG. 7 illustrates an embodiment of an occupancy sensor having a clock according to some of the inventive principles of this patent disclosure.

FIG. 8 illustrates an embodiment of a power pack having a clock according to some of the inventive principles of this patent disclosure.

FIG. 9 illustrates another embodiment of an occupancy sensor having a switching device and clock according to some of the inventive principles of this patent disclosure.

### DETAILED DESCRIPTION

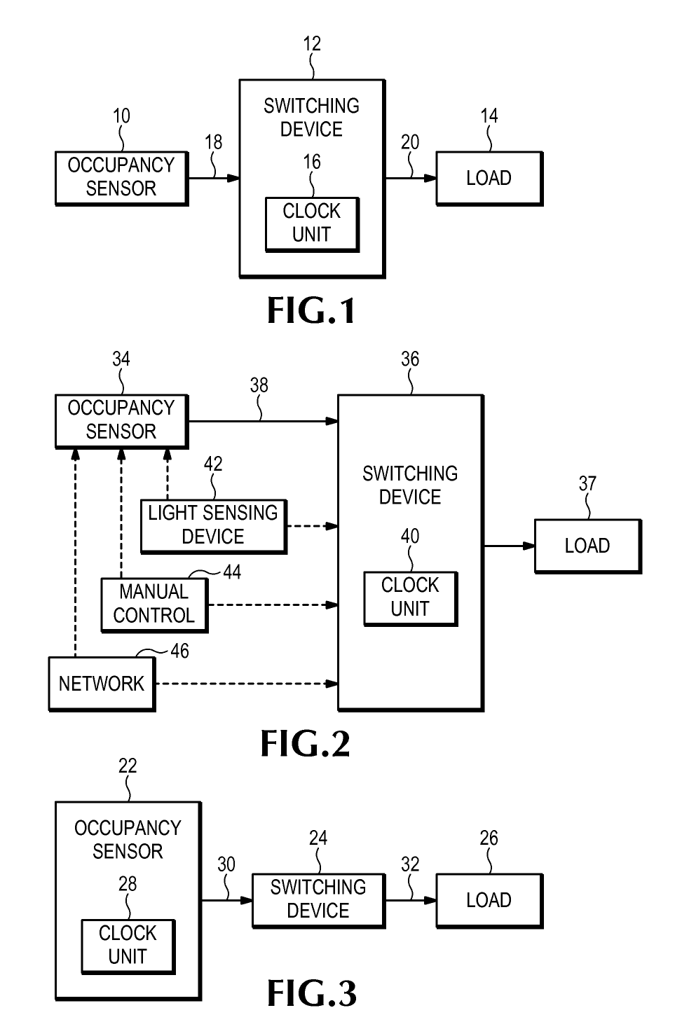

Some of the inventive principles of this patent disclosure relate to the use of a clock with a switching device for an occupancy sensing system. Referring to FIG. 1, an occupancy sensing system includes an occupancy sensor 10 and a switching device 12 having a clock unit 16. The switching device controls power to a load 14 through a power connection 20 in response to an occupancy signal received through a control connection 18.

The occupancy sensor 10 may be based on any suitable physical platform such as a ceiling mount device, wall mount device, wall switch, fixture-mount device, etc. The occupancy sensor may be based on any suitable sensing technology such as passive infrared (PIR), ultrasonic (U/S), audio, video, etc., or any combination thereof.

Any suitable electrical platform may be used. For example, a relatively sophisticated platform may include circuitry to process signals from a detector such as a PIR detector and provide an on/off occupancy signal that indicates whether the space is occupied or unoccupied. Such a platform may include features such as a built-in-time delay or other processing to prevent false triggering. Alternatively, a relatively simplistic electrical platform may be used in which the occupancy sensor sends primitive signals or raw data from a detector for further processing elsewhere in the system, for example in circuitry in the switching device.

The control connection 18 may include any form of connection suitable to provide control signaling, for example, low-voltage building wiring such as NEC Class 2 wiring. Alternatively, other forms of connections may be used including wireless connections such as radio frequency (RF) or infrared. Connections may also include network connections such as Control Area Network (CAN), Digital Addressable Lighting Interface (DALI), SectorNet, LonWorks, etc.

The switching device 12 may include any suitable form of isolated or non-isolated power switch including an air-gap relay, solid state relay, or other switch based on SCRs, triacs, transistors, etc. The switch may provide power switching in discrete steps such as on/off switching, with or without intermediate steps, or continuous switching such as dimming control. The switching device may be located in a suitable physical platform such as a wall switch, power pack, electrical panel, junction box, light fixture, fan housing, etc.

The switching device may be based on any suitable electrical platform and may include circuitry to implement decision making logic for controlling the power switches, processing signals from an occupancy sensor, interacting with a device clock or clock unit, etc. The electrical platform may be implemented with digital and/or analog hardware, software, firmware, etc., or any combination thereof.

The power connection 20 may include any form of connection suitable for the flow of power to the load, for example, insulated conductors in free space or in a conduit, cable, or other raceway. The power connections may operate at common high-voltages such as 120, 240 or 277 VAC, or at other voltages such as 12 VDC which is commonly used for outdoor landscaping. Terminations may be made through screw terminals, wire leads, spring terminals, or any other suitable method.

The load 14 may be located in, or arranged to serve, the space monitored by the occupancy sensor and may include lighting loads such as incandescent, fluorescent or other types of lighting; motors for exhaust fans, ceiling fans, or other types of motor loads; heaters for space heating or other uses; actuators for dampers, doors or other types of building or environmental controls; etc.

The clock unit 16 includes a device clock, which may include a time-of-day clock, day-of-week clock, etc., that is included in the same assembly, e.g., integrated in the same enclosure or chassis, as the switching device. The device clock may be based on any suitable platform as described in more detail below such as a completely electronic clock with an LCD display, a mechanical clock with a rotating contact mechanism, etc. Including the clock unit with the switching device may reduce the manufacturing, installation, maintenance, etc., costs associated with the clock since it may take advantage of an existing platform that may require little if any modification. It may also reduce installation errors, operator errors, reliability problems, etc. that may otherwise result from having the clock unit in a separate enclosure.

Including the clock unit with a switching device for an occupancy sensing system may provide numerous control methods according to some of the inventive principles of this patent disclosure. In one embodiment, the switching device may be controlled in response to the occupancy signal when the device clock indicates a first time period, but then the occupancy signal may be disregarded or not generated when the device clock indicates a second time period. For example, in a lighting control system, the clock unit and occupancy sensor may be configured to always keep the lights on during certain hours of certain days such as normal work hours during weekdays in an office, and only turn the lights on when occupancy is detected at other times during weekdays and on weekends. As another example, in a lighting system for a building space with unrestricted daylight sources, the clock unit and occupancy sensor may be configured to always keep the lights off during peak energy demand times such as mid-afternoon during summers, but turn the lights on based on occupancy sensing at other times. As yet another example, in a space heating system, the clock unit may turn a heating load off during setback hours, but turn the load on if the occupancy sensor detects an occupant.

In some embodiments, the system may be configured so that different occupancy sensor delay times are used during different times of day, days of week, etc. For example, during normal office hours on weekdays, a 20-minute time delay may be used to turn off the lights after the monitored space becomes unoccupied. During evenings or weekends, however, a two-minute time delay may be used to prevent leaving the lights on longer than necessary if the only anticipated occupancy during these hours is a security guard walk-through.

In some embodiments, multiple instances of the components or subcomponents shown in FIG. 1 may be combined to provide additional features. For example, the switching device 12 may include two independently controllable power switches to control two independent loads in response to the occupancy sensor 10 and clock unit 16. This may be useful, for example, in a bi-level switching system such as those that arrange alternate rows or groups of light fixtures, lamps within fixtures, etc., into separately switchable groups. In such an embodiment, the clock unit and occupancy sensor may be configured to turn on two groups of lamps for a space when an occupant is detected in a space during normal work or class hours, but only turn on one group of lamps when an occupant is detected at other times of the day or week.

In another embodiment, the system may include two separate switching devices 12, each having a separate clock unit 16, but controlled by the same occupancy sensor 10. In this embodiment, each switching device may operate with an independent time-of-day clock but in response to the same occupancy signal.

FIG. 2 illustrates another embodiment of an occupancy sensing system according to some of the inventive principles of this patent disclosure. The occupancy sensor 34, switching device 36 and clock unit 40 are similar to those of FIG. 1, but they may be configured to accommodate inputs from any or all of some additional devices such a light sensing device 42, a manual control 44, and a network 46.

In one embodiment, the light sensing device 42 may be implemented as a photocell that provides an analog or digital light-level signal to the switching device 36, which may use the light-level signal to provide continuous dimming control of a lighting load in conjunction with the clock unit. For example, during normal work or class hours, circuitry in the switching device may dim the lights if the light-level signal indicates a high level of ambient light. During other times, the system may turn the lights on at full intensity whenever an occupant is detected, regardless of the amount of ambient light.

In another embodiment, the light sensing device 42 may be implemented as a photocell that provides an on-off threshold signal to the occupancy sensor. For example, if the ambient light exceeds a certain level, the on-off signal from the photocell may override the occupancy signal, which in turn, may only be used during certain hours or days of the week based on the clock unit.

In other embodiments, a manual control 44 such as a touch pad, wall switch, remote control, etc., may be combined with the occupancy sensor 34 and clock unit 40. For example, in a classroom having a large exterior window area, the system can be configured to require actuation of a manual control to turn the lights on during certain “manual-on” hours. Once the lights are on, they may be turned off automatically when the occupancy sensor determines the classroom is unoccupied. During other hours, turn-on and turn-off may be fully automatic based on the occupancy sensor. The manual-on hours may be determined by the clock unit, for example, based on the times-of-day that classes are in session, and/or with further adjustment for times when large amounts of ambient light is expected to be available, such as during expected daylight hours during the school year. Operation can be configured for full automatic operation during summer when school is not in session.

In another embodiment, manual control 44 may be combined with the occupancy sensor 34, clock unit 40 and a switching device 36 having two independently controllable power switches to implement a bi-level switching system, for example, in a system having 3-lamp fluorescent fixtures where the inboard lamps in each fixtures are connected as a first group to be controlled separately from the outboard lamps which are connected as a second group. In this embodiment, the system may be configured so that, outside of normal office or classroom hours, the outboard lamps may only be turned on manually, but may be turned off manually, or by the occupancy sensor. Also outside of normal office or classroom hours, the inboard lamps are configured for automatic on and off operation, with an optional manual-off override.

During normal office or classroom hours, as determined by the clock unit, various configurations are possible. For example, during normal hours, the system may be configured for automatic-on and automatic-off operation of both groups of lamps based on the occupancy sensor, with a manual-off override of the outer group of lamps. As another example, during normal hours, the system may be configured for manual-on operation and automatic-off of both groups of lamps, with a manual-off override of the outer group of lamps. As a further refinement, a light sensor 42 may be included to selectively turn off either or both of the inboard and outboard groups of lamps depending on the amount of ambient light. Alternatively, a continuous light-level signal from the light sensor may be used to implement continuous dimming of either or both groups of lamps depending on the amount of ambient light during normal hours.

In another embodiment, a network interface 46 may be included to provide additional configuration capabilities or real-time functionality to the system. For example, in some embodiments, a clock unit may be included in a switching device that either has no display or is mounted in an inaccessible location. The network interface may provide access to the clock unit through a network for purposes of configuring the hours or days of operation, etc., in conjunction with the occupancy sensor and any other controls that may be included in the system. As another example, the network interface may be configured to provide updates such as changes to daylight savings time to the clock unit. As yet another example, a network interface may provide a connection to safety equipment such as a fire alarm system to coordinate control of lighting, HVAC and/or other building equipment with fire alarm or response systems. In another example, a network interface may provide a connection to a security system to coordinate control of lighting, HVAC and/or other building equipment with the security system. In this example, the system may ramp the lights up when an alarm is detected, and the ramp rate may vary depending on the time of day.

Some additional inventive principles of this patent disclosure relate to including a clock with an occupancy sensor. Referring to FIG. 3, a clock unit 28 is included with an occupancy sensor 22 rather than, or in addition to, a switching device as in the embodiment of FIG. 1. In the embodiment of FIG. 3, the occupancy sensor sends an occupancy signal to the switching device 24 through a control connection 30. The switching device controls power to a load 26 through a power connection 32 in response to the occupancy signal.

In some embodiments, the apparatus and connections shown in the system of FIG. 3 may be similar to those in the system of FIG. 1, and may be used to implement the various control techniques discussed above. Including the clock unit with the occupancy sensor may reduce the manufacturing, installation, maintenance, etc., costs associated with the clock since it may take advantage of an existing platform that may require little if any modification. It may also reduce installation errors, operator errors, reliability problems, etc. that may otherwise result from having the clock unit in a separate enclosure. Moreover, since an occupancy sensor is more likely to be mounted in an accessible location, it may provide better access to the clock unit for an installer, maintainer, user, etc.

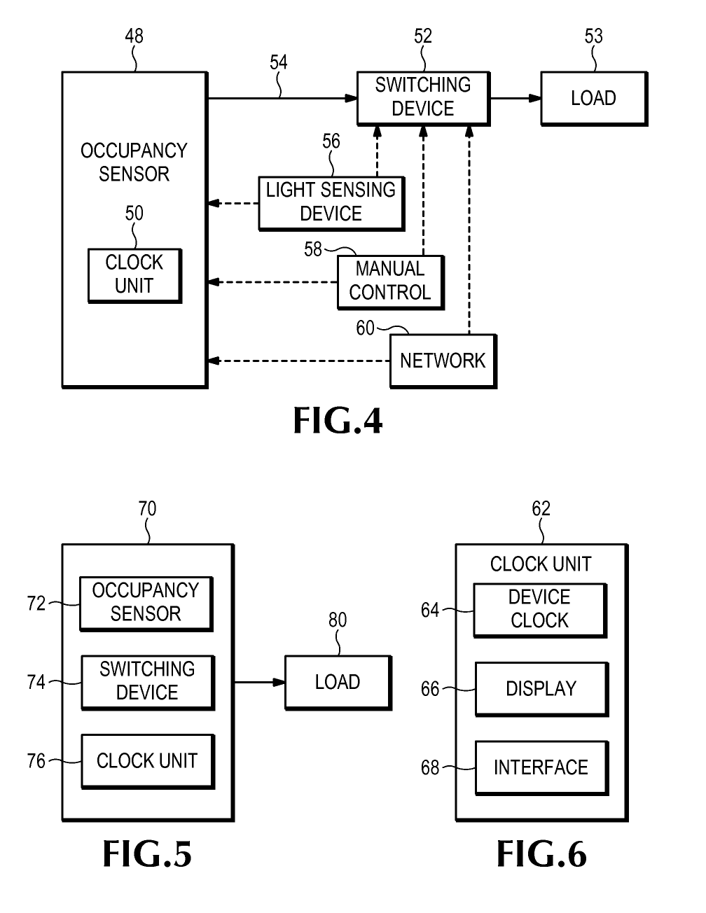

FIG. 4 illustrates another embodiment of an occupancy sensing system according to some of the inventive principles of this patent disclosure. The occupancy sensor 48, switching device 52 and clock unit 50 are similar to those of FIG. 3, but they may be configured to accommodate inputs from any or all of some additional devices such a light sensing device 56, a manual control 58, and a network interface 60. In some embodiments, the apparatus and connections shown in the system of FIG. 4 may be similar to those in the system of FIG. 3, and may be used to implement the various control techniques discussed above.

Some additional inventive principles of this patent disclosure relate to including an occupancy sensor, switching device, and clock unit in a single enclosure or chassis. Referring to FIG. 5, an enclosure or chassis 70 includes an occupancy sensor 72, a switching device 74 and a clock unit 76. The switching device controls the flow of power to a load 80 in response to control signals from the occupancy sensor and clock unit. In some embodiments, the apparatus and connections shown in the system of FIG. 5 may be similar to those in the systems of FIG. 1 and FIG. 3, and may be used to implement the various control techniques discussed above. In some embodiments, the system of FIG. 5 may also be configured to accommodate inputs from any or all of some additional devices such a light sensing device, a manual control, a network interface, etc., such as those shown in FIG. 2 and FIG. 4.

Some additional inventive principles of this patent disclosure relate to a clock unit for use with an occupancy sensor, switching device, etc., in an occupancy sensing system. Referring to FIG. 6, the clock unit includes a device clock 64, which may include a time-of-day clock, day-of-week clock, etc., that is included in the same assembly, e.g., integrated in the same enclosure or chassis, as the occupancy sensor, switching device, etc. The clock unit may also include a display 66 and/or an interface 68 to enable an installer, maintainer, user, etc., to communicate with the clock unit to set the time, date, and other parameters, to program and/or configure it for connections with other components, to program and/or configure the control strategy, etc. In some embodiments, the clock unit may include only the device clock with no display or interface. Some other embodiments may include the device clock with only a display or only an interface.

The device clock may be based on any suitable mechanical and/or electrical platform. For example, in some embodiments, the clock unit may be implemented as an electro-mechanical clock with a dial face having trippers arranged around the face to trigger on/off events by closing and opening mechanical contacts as the dial face turns. In other embodiments, the clock unit may be implemented completely with solid state electronics and may include an electronic display such as a liquid crystal display (LCD), light-emitting diode (LED) display, etc., for output and a keypad, touch screen, pushbuttons, etc., for input. In some embodiments, the display and/or local input apparatus may be omitted in favor of a network interface that may enable the device clock to be programmed and/or configured remotely through a wired or wireless network connection such as RF or infrared and may include network arrangements such as Control Area Network (CAN), Digital Addressable Lighting Interface (DALI), SectorNet™, LonWorks, etc. In some embodiments, the device clock may be located in the clock unit in the occupancy sensor, switching device, etc., while the display and/or input are located remotely from the occupancy sensor, switching device, etc.

In some embodiments, a clock unit may include an astronomical adjustment to adjust time settings based on seasons or time of year, for example, to extend the period of a manual-on control during summer when the hours of available daylight are longer.

A clock unit may be implemented with digital and/or analog hardware, software, firmware, etc., or any combination thereof. A clock unit may be integrated with apparatus in an occupancy sensor, switching device, etc., in any suitable manner. For example, in an occupancy sensor or power pack that already includes a microprocessor or microcontroller and a network interface, a device clock may be implemented purely by including additional time tracking software and allowing the clock to be programmed and/or configured through the network interface. That is, the clock unit may be implemented on an existing mechanical and/or electrical platform. Alternatively, an LCD display and keypad, along with suitable drive circuitry, may be added to the occupancy sensor or power pack, and the microprocessor or microcontroller may be reprogrammed to support the display and keypad and implement the clock features.

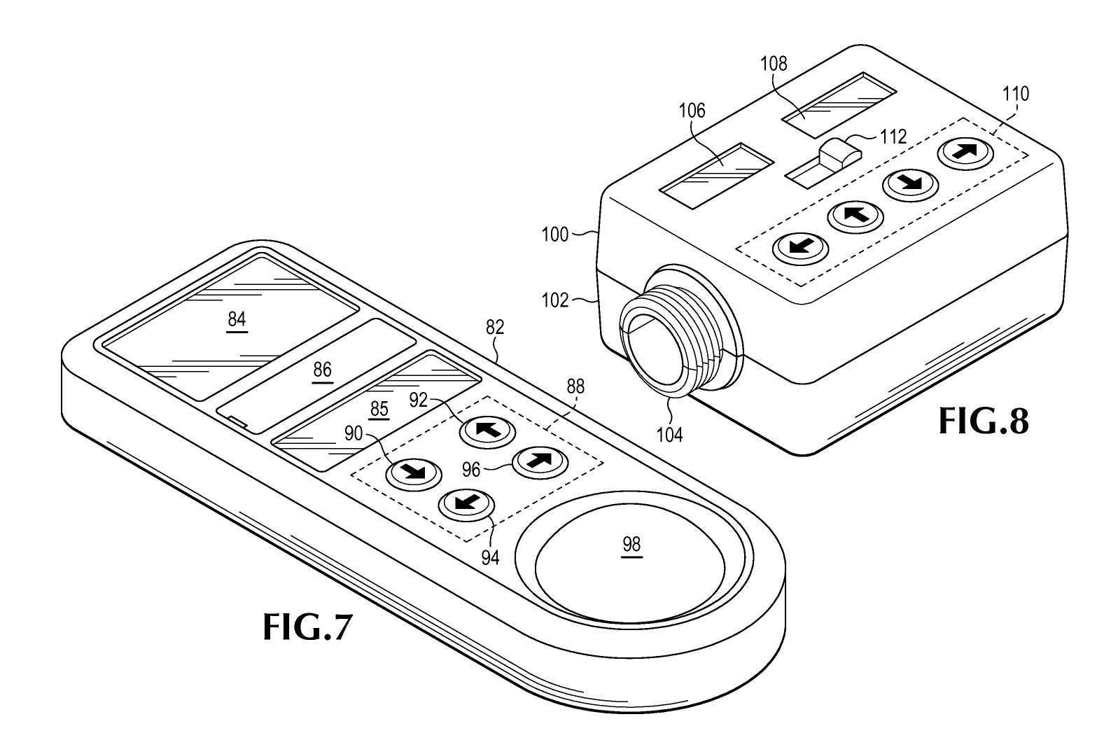

FIG. 7 illustrates an embodiment of an occupancy sensor having a clock according to some of the inventive principles of this patent disclosure. This embodiment is intended for operation as a wireless device that utilizes PIR sensing, but the inventive principles are not limited to these or any other details.

The embodiment of FIG. 7 includes a PIR detector 98 and a clock unit located in a common enclosure 82. An LCD display 85 and keypad interface 88 enable a user to set the time-of-day, day-of-week, program and configure the device clock, etc. In this example, the keypad interface 88 includes select buttons 94 and 96 to scroll through and select parameters, and increment-decrement buttons 90 and 92 to change a selected parameter. The functions of the clock unit may be implemented with a dedicated microcontroller, with a shared microcontroller that also implements the occupancy sensing and control communication functions, or with any other suitable hardware and/or software platform.

In this example, the occupancy sensor also includes a photovoltaic (PV) cell 84 to provide the primary source of power for the sensor and/or recharge a battery, or to supplement another source such as disposable or rechargeable batteries. An access cover 86 provides access to controls for the PIR sensing operation such as range, sensitivity, field of interest, learn mode, etc. The occupancy sensor may be mounted anywhere in any suitable manner. For example, it may be mounted to a ceiling or wall in the monitored space using self-adhesive pads, screws, clips, etc. The occupancy sensor may generate a wireless occupancy signal using RF, infrared, or any other suitable technology, which may be received by a switching device having an appropriate receiver and located, for example, in a wall switch, power pack, electrical panel, etc. In alternative embodiments, the occupancy sensor may be hardwired to the switching device.

In some embodiments, the PIR or other type of detector may also be used as an interface to provide input and/or output to the device clock. For example, a hand-held infrared remote control may be used to transmit programming and/or configuration information to the device clock through a PIR detector. This may eliminate the cost, space, etc., associated with the keypad or other clock interface. In a bi-directional embodiment, the clock unit may also transmit display information that may be displayed on a screen on the remote control, thereby eliminating the need for a display on the clock unit. For example, in an embodiment that employs active infrared detection technology, the detector may include an infrared emitter and an infrared receiver for occupancy sensing purposes. In such an embodiment, the receiver and emitter may also be used to receive programming and/or configuration information and transmit display information.

The inventive principles relating to the use of an occupancy sensing detector for a communication interface are applicable to any occupancy sensing system, methods or apparatus, not just those with device clocks.

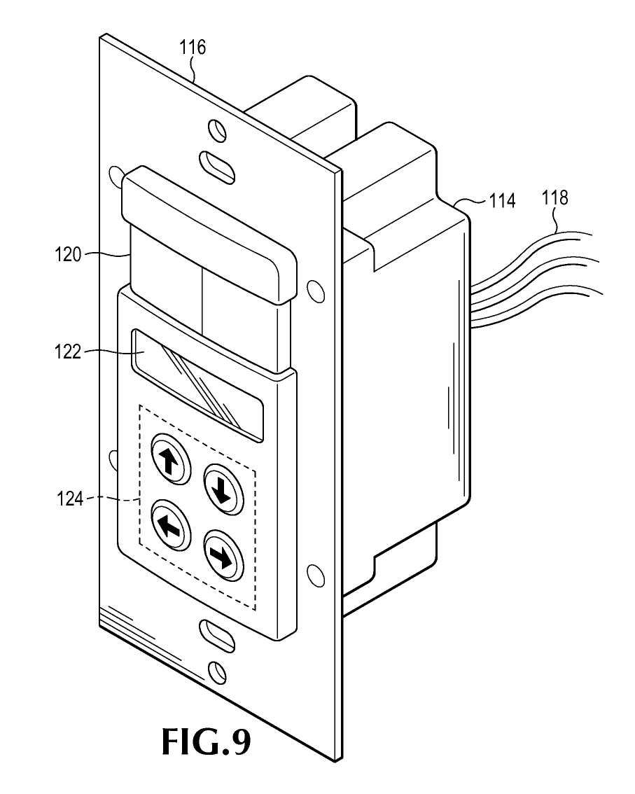

FIG. 8 illustrates an embodiment of a power pack having one or more clocks according to some of the inventive principles of this patent disclosure. The embodiment of FIG. 8 includes an enclosure having two housing halves 100 and 102. A conduit connection 104 molded into the housing halves provides a mechanical connection to a building wiring system at a junction box, light fixture, or other electrical enclosure or raceway. The power pack may include one or more switches to control the flow of power to one or more loads. The switches may operate at relatively high voltages such as 120, 240 or 277 VAC as is commonly used in building wiring systems, although some embodiments may operate at other voltages such as 12 VDC, e.g., for landscape wiring. The power pack may also include a power supply to convert high-voltage power to a low-voltage source for operating controls and control signals.

Power conductors for high voltage and/or low voltage power connections would typically pass through the conduit connection. In some embodiments, low voltage control conductors may also be routed through the conduit connection, but in other embodiments, low voltage control conductors may be routed through other openings in the housing. In yet other embodiments, control connections may be made through one or more wireless receivers such as an antennae, infrared receiver, ultrasound transducer, etc., which may be enclosed within the housing, attached outside of the housing, accessible through an opening in the housing, etc.

Although any number of power switches may be used, the embodiment of FIG. 8 is assumed to include two independently controllable switches to provide independent control of two different loads. The switches may be implemented as air-gap relays mounted to a circuit board which is located inside the enclosure and may also include a power supply and other control circuitry to operate the relays in response to control signals from an occupancy sensor, a clock unit, etc.

The power pack includes a clock unit having two independent device clocks, one for each relay. The clock unit includes two different LCD displays 106 and 108, one for each relay, but they share a common push-button interface 110. A slide switch 112 selects which device clock, and therefore, which display, is controlled by the interface. A center-off position on the slide switch may lock the interface and prevent it from modifying either of the device clocks. The device clocks may be implemented with digital or analog hardware, software, firmware, etc., or any combination thereof.

FIG. 9 illustrates an embodiment of an occupancy sensor having an integral switching device and device clock according to some of the inventive principles of this patent disclosure. The embodiment of FIG. 9 is configured as a wall-switch intended for mounting in a standard electrical wall box with mounting plate 116. The occupancy sensor includes a PR detector 120 which provides a wide field of view from a mounting location within a room. The occupancy sensor also includes a clock unit having an LCD display 122 and a keypad interface 124 to enable a user to set the time-of-day, set the time day-of-week, program and configure the device clock, etc. In this example, the keypad interface 88 includes left-right select buttons to scroll through and select parameters, and up-down increment-decrement buttons to change a selected parameter.

The occupancy sensor includes a switching device within the enclosure 114 to energize or de-energize lighting or other electrical loads for the room in response to the PR sensor and device clock. Connections to the occupancy sensor are through pigtail wire leads 118 which include hot, neutral, switched and ground connections.

The embodiments of FIG. 9 may enable components from other types of occupancy sensors to be reused and/or repurposed for an occupancy sensor with a device clock according to some of the inventive principles of this patent disclosure, thereby reducing the time and cost required for design, testing, manufacturing, etc.

The inventive principles of this patent disclosure have been described above with reference to some specific example embodiments, but these embodiments can be modified in arrangement and detail without departing from the inventive concepts. For example, some of the embodiments have been described in the context of lighting loads, but the inventive principles apply to other types of electrical loads as well. As another example, some of the embodiments have been described in the context of interior building spaces, but the inventive principles apply to exterior or hybrid spaces as well. Such changes and modifications are considered to fall within the scope of the following claims.

1. A system comprising:
a device clock; and
a switching device disposed to control power to a load in response to an occupancy signal and the device clock;
where the switching device and device clock are included in an assembly.

2. The system of claim 1 further comprising a display coupled to the device clock.

3. The system of claim 1 further comprising an interface to input information to the device clock.

4. The system of claim 3 where the interface comprises a keypad.

5. The system of claim 1 where the assembly comprises a power pack.

6. The system of claim 1 further comprising an occupancy sensor included in the assembly.

7. The system of claim 6 where the assembly comprises a wall switch.

8. A method comprising:
controlling a switching device in response to an occupancy signal and a device clock;
where the switching device and device clock are included in an assembly.

9. The method of claim 8 where the assembly includes an occupancy sensor disposed to generate the occupancy signal.

10. The method of claim 8 further comprising disregarding the occupancy signal when the device clock indicates a first time period.

11. The method of claim 10 further comprising controlling the switching device in response to the occupancy signal when the device clock indicates a second time period.

10. A system comprising:
a device clock; and
an occupancy sensor disposed to generate an occupancy signal in response to a signal from a detector and the device clock;
where the occupancy sensor and the device clock are included in an assembly.

11. The system of claim 10 where the assembly comprises a ceiling mount apparatus.

12. The system of claim 10 where the assembly comprises a wall mount apparatus.

13. The system of claim 10 further comprising a network interface coupled to the occupancy sensor.

14. A method comprising:
generating an occupancy signal in response to a signal from the detector and a device clock;
where the detector and the device clock are included in an assembly.

15. The method of claim 14 further comprising transmitting the occupancy signal to a switching device.

16. The method of claim 15 where the occupancy signal is generated in response to the signal from the detector when the device clock indicates a first time period.

17. The method of claim 16 where the occupancy signal is not generated in response to the signal from the detector when the device clock indicates a second time period.

18. The method of claim 14 further comprising generating the occupancy signal in response to a light-level signal from a light sensing device.

19. The method of claim 14 further comprising generating the occupancy signal in response to a manual control.

20. An occupancy sensor comprising:
a detector; and
circuitry disposed to generate an occupancy signal in response to a signal from the detector;
where the detector is disposed to operate as a communication interface for the occupancy sensor.

21. The occupancy sensor of claim 20 where the detector comprises an infrared detector.

22. The occupancy sensor of claim 10 where the occupancy sensor comprises a wireless occupancy sensor.

23. A method comprising:
generating an occupancy signal in response to a signal from a detector; and
operating the detector as a communication interface.

24. The method of claim 23 further comprising transmitting information to a device clock through the communication interface.

25. The method of claim 23 further comprising transmitting information from a remote control through the communication interface.

26. The method of claim 25 further comprising transmitting display information to through the communication interface.
